(19) United States
(12) Patent Application Publication
(10) Pub. No.: US 2009/0283214 A1
(43) Pub. Date: Nov. 19, 2009

(54) Device and method for separating adhesive

(76) Inventor: Jack Richard Nelson, Garden City, CA (US)

Correspondence Address: J. Richard Nelson, 5920 McKinley Dr., Garden Valley, CA, 95633, US

(21) Appl. No.: 12/152,786

(22) Filed: May 16, 2008

(51) Int. Cl. B29C 63/00

(52) U.S. Cl. 156/344; 156/584

(57) ABSTRACT

A device and method for separating adhesive includes a gear and a tension element. The device may be designed to stall before the tension element can break.

### FIELD OF INVENTION

The present invention relates generally to an adhesive cutting device, and, more particularly, to a device and method for separating adhesive between two objects.

### BACKGROUND

It is frequently necessary to separate an adhesive that has been used to permanently join two surfaces or to fill a gap between two surfaces. For example, sealant is used to join glass to a window casing or a bead of silicone adhesive may be used to bond two objects together. Repair, rehabilitation, remodeling or retrofitting may necessitate separation of this type of adhesive.

In some applications, it is desirable to separate the adhesive as quickly as possible, as in industrial settings. In these scenarios, revenue may be dependent on volume and completion of work on as many pieces as possible in a short period of time. For example, in auto body work, higher throughput leads to greater income. Rapid separation of adhesives can contribute to that higher throughput.

It may also be important to remove the adhesive with minimal damage to surfaces surrounding the adhesive. For example, when removing broken window glass in residential settings, limiting damage to window casings is more pleasing to the home owner.

In other applications, it may be difficult to access one side of a work surface. For example, a container may be sealed shut by use of an adhesive between the container and the lid. In another example, replacing a sheet metal panel on the side of a train car is best accomplished solely from the exterior of the train. Any separation of the adhesive would have to be accomplished entirely from the outside of the container.

In some applications, separation of adhesive requires strenuous physical effort or the labor of multiple individuals. For example, when replacing a windshield in a large truck, it is virtually impossible for one person to work on both sides of the panel. Requiring two workers for the adhesive-separation process can be costly in a commercial setting.

It can also be difficult to separate the adhesive with precision. Frequently, separation of the adhesive results in damage or destruction to the joined objects or surfaces, such as breakage of a large windshield when its adhesive is removed to facilitate painting of the vehicle.

Current methods of separating adhesives can be harmful to equipment, work surfaces and operators. Cutting adhesives with a sharp blade frequently results in cutting the worker or the adjoining surface. Breakage of the cutting and separating implements is also a frequent problem. Painted surfaces can be scratched and require repair to prevent rust.

In addition, many environments can be difficult to work in. For example, removing the windshield from a small automobile may involve the worker trying to maneuver himself or herself and equipment in a small awkward space.

The disclosed device and method are directed toward achieving one or more of the goals set forth above.

### SUMMARY

One aspect of the present disclosure is directed to an adhesive-separating device. The device may include a traction element such as a wire or metal band. The adhesive-separating device may also include a winding shaft. The winding shaft may bear a number of through bores at acute angles to the longitudinal axis of the shaft. The adhesive-separating device may also include a gear and a variable-speed actuator. The actuator may also be operable by a wired or wireless remote-control device. A vacuum pump and pad configured to allow attachment of the adhesive-separation device to a work surface may also be included.

Another aspect of the present disclosure is directed to a method for separating adhesive. The method may include the steps of: affixing an adhesive-separating device to a work surface; affixing the end of a traction element to the winding shaft of the adhesive-separating device; aligning the length of the traction element with the length of the adhesive; affixing the second end of the traction element; and, engaging an actuator of the adhesive-separating device to wind the traction element onto the winding shaft. The traction element may be drawn through or past the adhesive, from one side to the other and the adhesive-separating device and the first end of the traction element may be affixed on opposite sides of a work surface. The speed of the actuator may be adjusted by means of a wired or wireless remote control. The adhesive-separating device may be affixed to a work surface by use of a vacuum pump.

Further aspects of the nature and advantages of the invention will become apparent from the summary above and the following detailed description when taken in conjunction with the drawings.

### BRIEF DESCRIPTION OF THE DRAWINGS

The accompanying drawings, which are incorporated in and constitute a part of this specification, illustrate an implementation of the invention and, together with the description, explain the goals, advantages and principles of the invention. Corresponding reference numerals indicate corresponding parts throughout the several views of the drawings. In the drawings:

FIG. 1 is a diagrammatic illustration of an exemplary adhesive-separating device;

FIG. 2 is a diagrammatic illustration of several exemplary winding shaft configurations of an exemplary adhesive-separating device;

FIG. 3 is another diagrammatic illustration of an exemplary adhesive-separating device;

FIG. 4 is another diagrammatic illustration of an exemplary adhesive-separating device; and

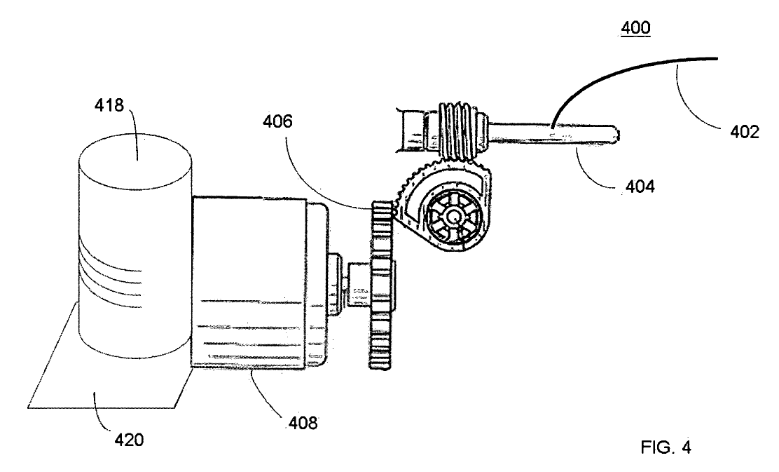

FIG. 5 is another diagrammatic illustration of an exemplary adhesive-separating device.

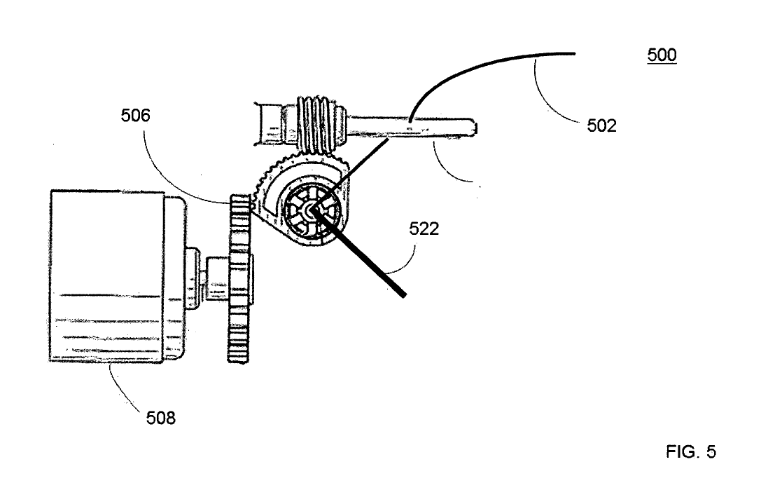

FIG. 6 is a diagrammatic illustration of an exemplary method of separating adhesive.

FIG. 7 is a diagrammatic illustration of the execution of an exemplary method of separating adhesive.

### DETAILED DESCRIPTION

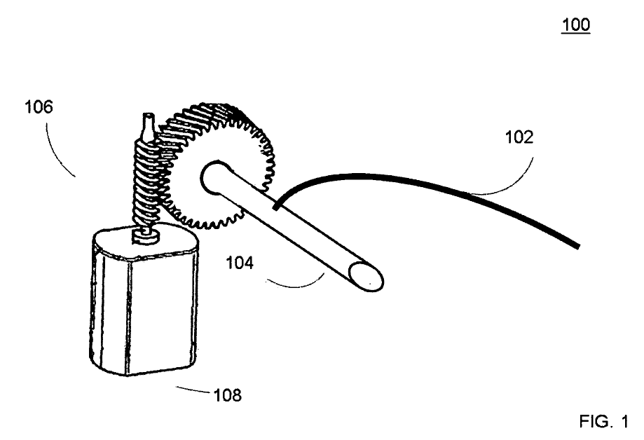

An adhesive-separation device, constructed according to the principles of the present disclosure, is indicated generally as 100 in FIG. 1. The adhesive-separation device 100 generally comprises a traction element 102, a winding shaft 104, a gear 106, and a variable-speed actuator 108. The elements of the adhesive-separation device may be exposed or partially or fully enclosed in a housing. Separation of adhesive may include cutting, pealing, dissolving, melting or any other method known in the art to separate an adhesive from itself or from an object. Within the meaning of this disclosure, adhesive refers to any substance that tends to bind or cause adherence and includes, but is not limited to, glue, caulk, sealant, laminating agents, thermoplastics, epoxies and tapes.

The traction element 102 may be a wire, an synthetic fiber, a steel band, a nylon filament or any other material, known in the art. The traction element 102 may be of high-tensile strength such as a high-tensile strength wire. The traction element 102 may be selected to match the separating requirements of the particular application. For example, a wire of 1500 MPa tensile strength or greater may be used in separating very strong adhesives as might be found in attaching a car windshield. Alternatively, a nylon filament of 500 MPa might be selected to separate a relatively soft adhesive.

The variable-speed actuator 108 may be an electrical actuator, a pneumatic actuator, a mechanical actuator, a piezoelectric actuator or any other actuator known in the art. The variable-speed actuator 108 may be in driving communication with the gear 106 and winding shaft 104. Driving communication may be achieved by gears, shafts, pinions, direct connection or any other means known in the art.

The variable-speed actuator 108 may be configured to operate via wired or wireless remote control. The wireless remote control may operate by any frequency technology including infrared, microwave or radio wave. The variable speed actuator 108 may be configured to allow setting or adjustment of the speed of operation by the operator, by a mechanized signal such as a servomechanism, by automated controls such as a computer program, or any other method known in the art. The adjustment of the speed of operation of the variable-speed actuator 108 may be achieved by switches, sensors, digital signal or any other method known in the art.

The variable-speed actuator 108 may be configured to stall when the load on the actuator is at or approaching the tensile-strength of the traction element 102. For example, if the tensile strength of the traction element 102 is 1000 MPa, the variable-speed actuator 108 may be configured to stall when the load or resistance on the variable-speed actuator 108 is 999 MPa. This would allow the variable-speed actuator to stop operation automatically before the traction element 102 breaks. The variable-speed actuator 108 may be configured to maintain constant tension on the traction element 102. The variable-speed actuator 108 may be configured to maintain constant rotational velocity without regard to tensile strength of the traction element.

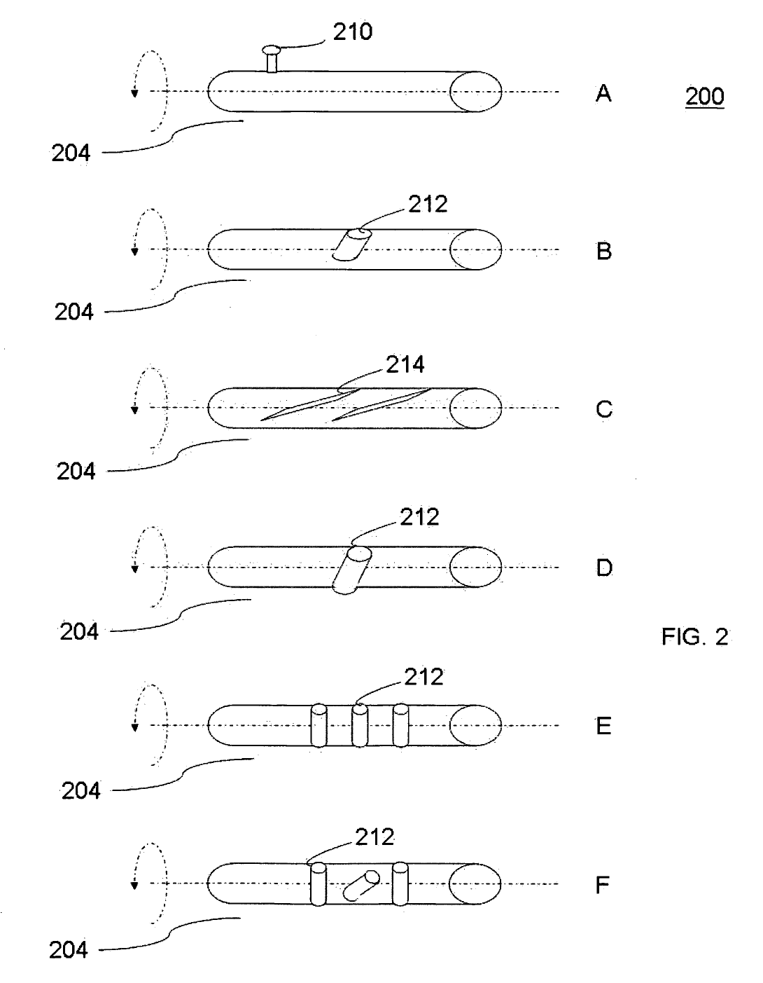

An embodiment of the winding shaft 204 is indicated generally as 200 in FIG. 2. The winding shaft 204 may be configured to receive the traction element 102. Reception of the traction element may be achieved by a set screw 210, a bore 212, a slot 214 or any other mechanism known in the art. The winding shaft 204 may be configured with one or more set screws 210, bores 212 or slots 214, as illustrated in views E and F of FIG. 2. The set screws 210, bores 212 or slots 214 may be aligned with each other (view E of FIG. 2) or offset from one another (view F of FIG. 2). The bore 212 may be a through bore as illustrated in view D of FIG. 2. The set screws 210, bores 212 or slots 214 may be perpendicular to the rotational axis of the winding shaft 204 as illustrated in views A and E of FIG. 2. The set screws 210, bores 212 or slots 214 may be at non-perpendicular angle to the rotational axis of the winding shaft 204 as illustrated in views C and D of FIG. 2.

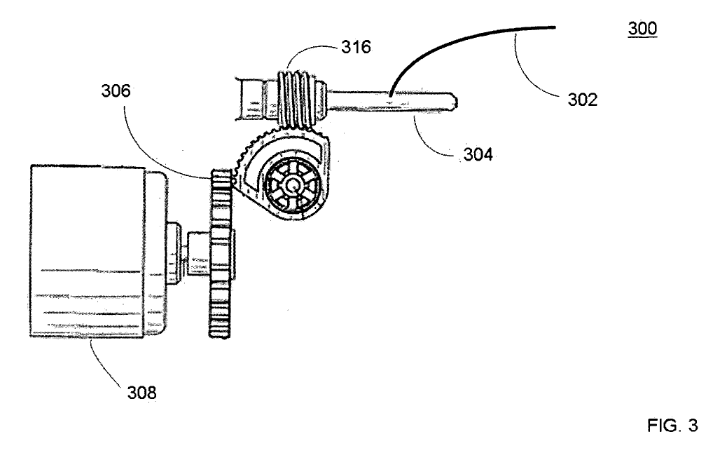

The gear 106 may be in driving communication with the winding shaft 104 and the variable-speed actuator 108. The driving communication may be achieved via a worm, a spline, a cog or any other mechanism known in the art. The device may include more than one gear. In one exemplary embodiment, indicated generally as 300 in FIG. 3, the gear 306 may be a worm gear configured to engage a worm 316 formed as part of the winding shaft 304.

The embodiment of the adhesive-separation device 400 may include a means for attaching 418 the device to a surface. The attachment means may be a vacuum pump 418 and vacuum pad 420 arrangement, a mechanical clamp arrangement, a suction cup arrangement, a screw, nail, or other fastener arrangement, a peg-and-hole arrangement or any other arrangement, known in the art, suitable for securing the adhesive-separation device 400 during operation.

The embodiment of the adhesive-separation device 500 may include a means for disengaging 522 the winding shaft 504 from operational communication with the gear 506. The disengagement means 522 may include a lever, a button, a knob or any other means, known in the art, to allow the winding shaft 504 to be operationally separated from the gear 506 and thereby from the variable-speed actuator 108. The disengagement means 522 allows the winding shaft to be quickly manipulated by the operator during use of the adhesive-separation device 500 thereby facilitating replacement of the shaft or reattachment of the traction element 102.

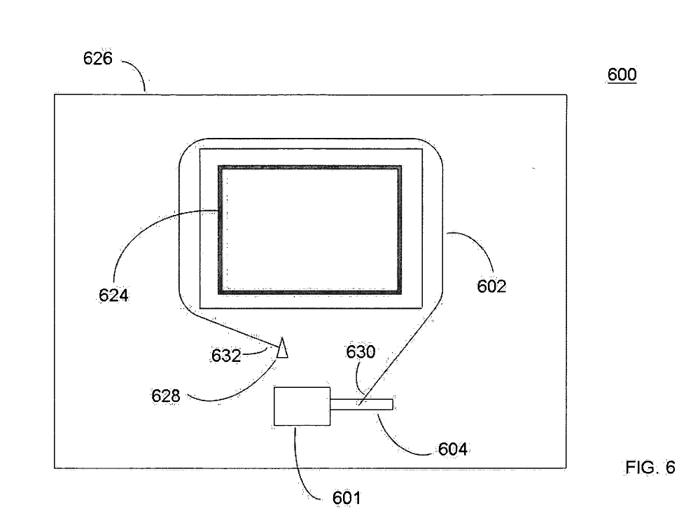

The method of separating adhesive using the adhesive-separation device is generally shown as 600 in FIG. 6. The method generally comprises the steps of affixing an adhesive-separating device 601 to a work surface 626, affixing a first end 630 of a traction element 602 of the adhesive-separating device 601 to a winding shaft 604 of the adhesive-separating device 601, aligning the length of the traction element 602 with the length of the adhesive 624, affixing a second end 632 of the traction element 602, and, engaging an actuator of the adhesive-separating device 601 to effect winding of the traction element 602 about the winding shaft 604.

The method of separating adhesive may include a step of passing the traction element 602 from one side of an adhesive 624 to the other side of the adhesive. Passing the traction element 602 may include piercing the adhesive with the traction element 602 or a tool, wrapping the traction element 602 around the end of the adhesive, prying the traction element 602 between the adhesive and the surface to which it is attached, or any other method known in the art.

The adhesive-separating device 601 may be affixed to a work surface 626 by any means sufficient to provide resistance to the tension element 602. The adhesive-separation device 601 may be affixed by engaging a vacuum pump and vacuum pad assembly, by applying mechanical clamps, by engaging a suction cup, by securing a screw, nail or other fastener, by inserting a peg into a hole or by any other method known in the art.

The adhesive-separating device 601 may be affixed on the same side of the work surface 626 as the second end 632 of the traction element 602. Alternatively, the adhesive-separating device 601 may be affixed to the opposite side of the work surface 626 from the second end 632 of the traction element 602. For example, when using the method to separate the adhesive joining a windshield to a car, the adhesive-separating device 601 may be affixed directly to the windshield on the inside of the car and the second end 632 of the traction element 602 may be affixed to a point on the outside of the car such as a windshield wiper post.

The speed of the actuator of the adhesive-separating device 601 may be adjusted as the separation process progresses. The speed may be adjusted by use of a wired or wireless remote control, switches, sensors, automated digital controls, servomechanisms or any other method known in the art.

The first end 630 of the traction element 602 may be affixed to a winding shaft 604 of an adhesive-separating device 601 by means of a set screw, a slot, a bore, or any other means known in the art. In the event that the traction element 602 becomes separated from the winding shaft 604, as in the case of breakage of the traction element, the original first end 630 or the new first end created by breakage, can be reaffixed to the winding shaft 604. The winding shaft may bear a plurality of attachment means allowing the traction element 602 to be reaffixed to the winding shaft 604 by the same attachment means or a new attachment means.

The second end 632 of the traction element 602 may be affixed to any functional point 628. The second end 632 may be affixed to an element integral with work surface, to a removable tool designed specifically for the purpose of fixing the second end 632 during operation of the adhesive-separation device, to a fixing point built into the adhesive-separation device itself, or any other point, known in the art, suitable for securing the traction element 602 during operation of the adhesive-separation device.

The second end 632 of the traction element 602 may be attached by forming a loop in the second end 632 that allows it to be hooked over a device, by forming an enlarged protuberance that will not pass through a small opening and thereby secures the second end 632, by wrapping the second end about a screw or other object, by threading the second end 632 through an opening as in a needle and crimping the free end back to the traction element 602, by tying a knot or any other method known in the art. Numerous other methods affixing the second end 632 of the traction element 602 will be apparent to one of ordinary skill in the art and are equally viable adaptations.

The method of separating adhesive using the adhesive-separation device may also include the steps of stopping the actuator, releasing the second end 632 of the traction element 602 from the point where it was affixed 628, affixing the second end 632 of the traction element 602 again, and reengaging the actuator. The adhesive-separation device 601 may be moved to a new position and reaffixed as well. These steps allow for repositioning the device to optimize the angle of the traction element 602 during the adhesive-separation process.

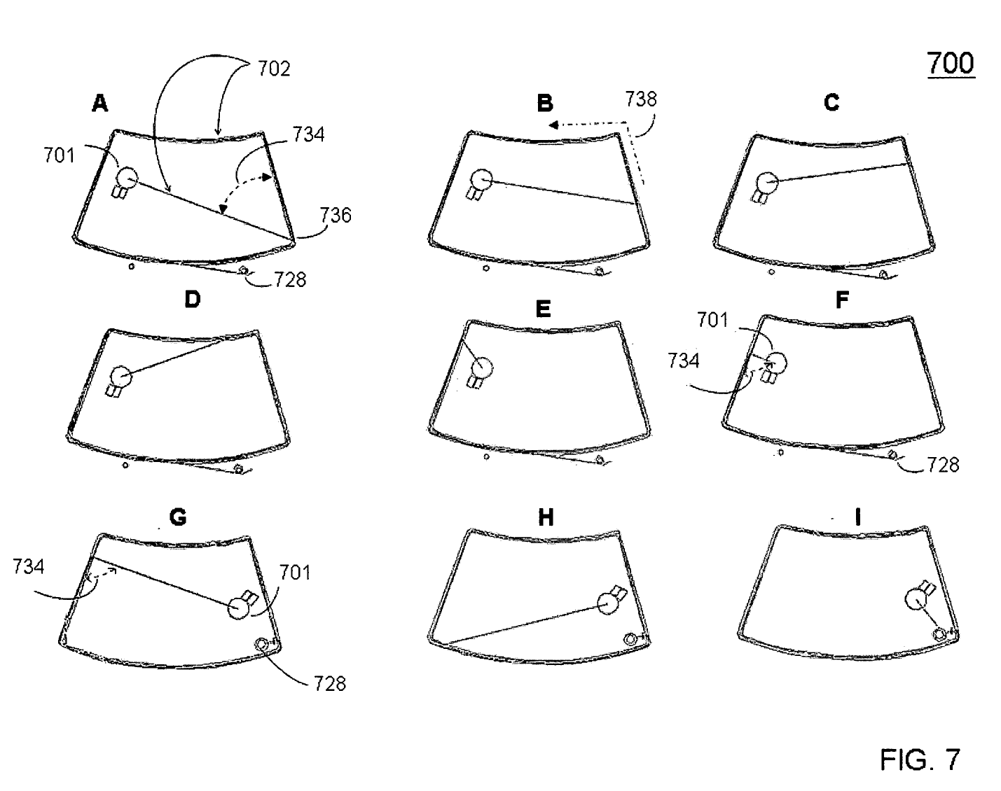

FIG. 7 is an illustration of an exemplary method of separating adhesive showing the successive progress of the traction element 702 during the adhesive-separation process as well as the repositioning of the adhesive-separation device 701. This depiction uses a car windshield as an example; however, other applications of the method would be equivalent. In this example, the traction element 702 has been passed through the adhesive at one point 736, and aligned along the edge of the adhesive as it runs along the edge of the window. The arrow 738 depicts the path of aligning the traction element 702 along the edge of the adhesive. The first end of the traction element 702 has been attached to the winding shaft of an adhesive-separation device 701 on the inside of the windshield and the second end of the traction element has been affixed to a point 728 on the outside of the windshield. (Reference numbers are shown in view A of FIG. 7 but left out the remaining views for clarity.) As the adhesive-separation device 701 is engaged, the traction element 702 separates the adhesive and moves along the path of the adhesive. Progress along the path can be seen in successive views B, C, D, E, F, G, H and I. The positioning of the adhesive-separation device 701 is preferably in a location that allows the angle 734 described by the two portions of the traction element 702 as it meets the adhesive to be less than 90°. When the angle 734 between the portion of the traction element 702 being wound on the winding shaft and the portion aligned with the adhesive approaches 90° as seen in view F, the adhesive-separation device is preferably relocated by stopping the actuator, releasing the second end 732 of the traction element 702 from the point where it was affixed 728, affixing the second end 732 of the traction element 702 again, releasing the adhesive-separation device 701, reaffixing the adhesive-separation device 701 in a new position and then reengaging the actuator. Views F and G of FIG. 7 show the first and second positions, respectively, of the adhesive-separation device 701 and the affixing point 728 in this example.

It will be apparent to those skilled in the art that various modifications and variations can be made to the disclosed device and method. Other embodiments will be apparent to those skilled in the art from consideration of the specification and practice of the disclosed system and method. It is intended that the specification and examples be considered as exemplary only, with a true scope being indicated by the following claims and their equivalents

I claim:

1. An adhesive-separating device, comprising:
a traction element;
a winding shaft configured to receive the traction element;
a gear in driving communication with the winding shaft; and
a variable-speed actuator in driving communication with the gear and the winding shaft.

2. The adhesive-separating device of claim 1, wherein the variable-speed actuator is configured to operate by remote control.

3. The adhesive-separating device of claim 1, wherein the variable-speed actuator is configured to stall when the load on the variable-speed actuator approaches the tensile-strength of the traction element.

4. The adhesive-separating device of claim 1, wherein the traction element is high-tensile strength wire.

5. The adhesive-separating device of claim 1, wherein the winding shaft is configured with a bore capable of receiving the traction element.

6. The adhesive-separating device of claim 5, wherein the bore is a through bore.

7. The adhesive-separating device of claim 5, wherein the bore is perpendicular to the axis of the winding shaft.

8. The adhesive-separating device of claim 5, wherein the winding shaft is configured with a plurality of bores capable of receiving the traction element.

9. The adhesive-separating device of claim 1, wherein the gear is a worm gear.

10. The adhesive-separating device of claim 1, wherein the actuator is an electric actuator.

11. The adhesive-separating device of claim 1, further comprising a battery power supply.

12. The adhesive-separating device of claim 1, further comprising a means for attaching the housing to a surface.

13. The adhesive-separating device of claim 12, wherein the attachment means comprises a vacuum pump.

14. The adhesive-separating device of claim 1, further comprising a means for disengaging the winding shaft from the adhesive-separating device.

15. An adhesive-separating device, comprising:
a high-tensile-strength wire;
a winding shaft configured with a plurality of through bores capable of receiving the high-tensile-strength wire;
a worm gear in driving communication with the winding shaft;
a variable-speed electric actuator in driving communication with the worm gear, further configured to stall when the load on the variable-speed actuator approaches the tensile strength of the high-tensile-strength wire;
a battery power supply; and,
a vacuum pump.

16. A method for separating adhesive, comprising the steps of:
Affixing an adhesive-separating device to a work surface;
Affixing a first end of a traction element of the adhesive-separating device to a winding shaft of the adhesive-separating device;
Aligning the length of the traction element with the length of the adhesive;
Affixing a second end of the traction element; and,
Engaging an actuator of the adhesive-separating device to effect winding of the traction element about the winding shaft.

17. The method of claim 16, further comprising the step of passing the traction element from one side of an adhesive to the other side of the adhesive.

18. The method of claim 16, wherein the adhesive-separating device and the second end of the traction element are affixed on opposing sides of the work surface.

19. The method of claim 16, further comprising the step of adjusting the speed of the actuator.

20. The method of claim 19, wherein the speed of the actuator is adjusted by use of a remote control device.

21. The method of claim 16, wherein affixing the first end of the traction element to a winding shaft comprises inserting the traction element into a bore on the winding shaft.

22. The method of claim 16, further comprising the step of reaffixing the first end of the traction element in the event of separation of the traction element from the shaft.

23. The method of claim 16, wherein the second end of the traction element is affixed directly to the adhesive-separating device.

24. The method of claim 16, further comprising the steps of:
Stopping the variable-speed actuator;
Releasing the second end of the traction element from the point where it was affixed;
Affixing the second end of the traction element again;
Reengaging the actuator.

25. The method of claim 24, wherein the second end of the traction element is affixed directly to the adhesive-separating device.

26. The method of claim 16, wherein the adhesive-separating device is affixed to a work surface by means of a vacuum pump.
